(19) United States
(12) Patent Application Publication
(10) Pub. No.: US 2012/0030991 A1
(43) Pub. Date: Feb. 9, 2012

(54) Floating fishing lure supporting a dancing bait on the water surface

(76) Inventor: Philip N. Chatfield, Springfield, OH (US)

(21) Appl. No.: 12/806,159

(22) Filed: Aug. 6, 2010

(51) Int. Cl. A01K 85/00; A01K 91/00

(52) U.S. Cl. 43/42.39; 43/42.49; 43/43.1

(57) ABSTRACT

A floating fishing lure includes a buoyant body having an upper portion projecting above the water surface and a lower portion projecting below the water surface. The upper portion supports the inner end of one or more elongated flexible elements or spring wires which project upwardly and radially outwardly in the air above the water surface. A bait including a fish hook is connected to the outer end portion of each flexible wire by a leader line and is supported adjacent the water surface when the body is floating. When the body supports a plurality of flexible elements or spring wires and corresponding baits, the wires are uniformly spaced around the body and extend in radial directions from the body. The floating body and each spring wire cooperate to produce a dancing effect of each bait on the water surface.

### BACKGROUND OF THE INVENTION

The present invention relates to floating fishing lures, for example, as disclosed in U.S. Pat. Nos. 5,113,614, 5,560,141, 7,082,711 and Des. 559,940, and which include flotation members or floats or bobbers which maintain the fishing lure adjacent the water surface. Many of such fishing lures support a bait or hook below the water surface, such as disclosed, for example, in U.S. Pat. No. 5,113,614, and many fishing lures maintain the bait or hook adjacent the water surface, such as disclosed, for example, in U.S. Pat. No. 5,560,141. The bait may be a natural bait such as a live worm as shown in the '614 patent or the bait may be an artificial bait or fly with a hook, as shown in the '141 patent.

### SUMMARY OF THE INVENTION

The present invention is directed to a floating fishing lure which supports a live or artificial bait or a plurality of baits adjacent the water surface and provides the effect of each bait bouncing or dancing on the water surface in response to any movement of the water and/or movement of the fishing lure. The fishing lure of the invention includes a buoyant body which floats and bobs on the water surface. An elongated flexible element or spring wire has an inner portion connected to the body and projects upwardly and laterally outwardly from the body above the surface of the water. An outer portion of the flexible element are spring wire supports a bait adjacent the surface of the water when the body is floating on the water, and the bait comprises a fish hook. The buoyant body and the flexible element or spring wire cooperate to produce a dancing effect of the bait on the surface of the water or the appearance of a bait or fly landing on the water surface in response to movement of the water and/or the floating body. The buoyant body may support a plurality of angularly arranged flexible elements or spring wires and corresponding baits each of which has an independent dancing effect on the water surface.

Other features and advantages of the invention will be apparent from the following description, the accompanying drawings and the appended claims.

### BRIEF DESCRIPTION OF THE DRAWINGS

FIG. 1 is an elevational view of a floating fishing lure constructed in accordance with the invention and illustrating a floating body supporting a plurality of flexible spring wires supporting and corresponding baits adjacent the water surface;

FIG. 2 is a plan view of the floating fishing lure shown in FIG. 1; and

FIG. 3 is a fragmentary axial section of the fishing lure shown in FIGS. 1 and 2.

### DESCRIPTION OF THE ILLUSTRATED EMBODIMENT

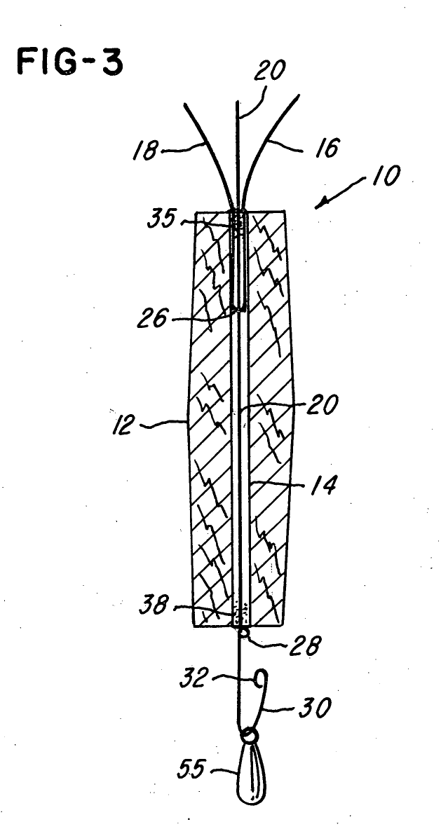

A fishing lure 10 includes an elongated buoyant body 12 which functions as a float or bobber and is constructed of a floating material such as balsa wood or polyurethane foam or a hollow molded plastic material, commonly used for the construction of a fishing lure float or bobber. However, as illustrated, the body 12 is constructed of balsa wood as shown in FIG. 3 and has a length of about 4 inches, a diameter at the center of about 1 inch and a diameter at each end of about ⅞ inch. As also shown in FIG. 3, the elongated body 12 has an axially extending center hole 14 of about ⅛ inch. A set or plurality of elongated flexible elements in the form of stainless steel spring wires 16, 18 and 20 project upwardly and curve outwardly from the top center of the body 12 and are preferably spaced at equal angles around the body. Each of the stainless steel spring wires has a length of about seven inches and a diameter of about 0.025 inch and has an integrally formed wire fastener 24 at the outer end portion of the wire. Each fastener 24 may be in the general form of a safety pin with a hook end portion for releasably engaging the wire, but other connector means may be formed from each wire such as a simple eyelet.

Referring to FIG. 3, the spring wire 16 and 18 are formed from a single piece or section of spring wire by bending a center portion of the wire to form an elongated U-shaped loop 26 which is inserted into the upper portion of the center hole 14. The third wire 20 extends downwardly completely through the center hole 14 within the body 12 and forms a circular eyelet 28 at the bottom end of the body 12. The wire 20 extends further to form a releasable fastener 30 similar to each of the fasteners 24 and generally similar to a safety pin. The fastener 30 and each of the fasteners 24 has an integrally formed hook-shaped end portion 32 so that the hook portions 32 releasably engage the corresponding wire 16, 18 and 20. After the loop portion 26 of the wire 16 and 18 is inserted into the upper end portion of the hole 14, and the lower end portion of the wire 20 with the formed eyelet 28 and fastener 30, is extended through the hole 14, a charge of water resistant liquid adhesive or epoxy 35 is inserted or injected into the upper end portion of the hole 14, and another charge of adhesive or epoxy 38 is inserted or injected into the lower end portion of the hole 14 for securing the spring wires 16, 18 and 20 within the float body 12.

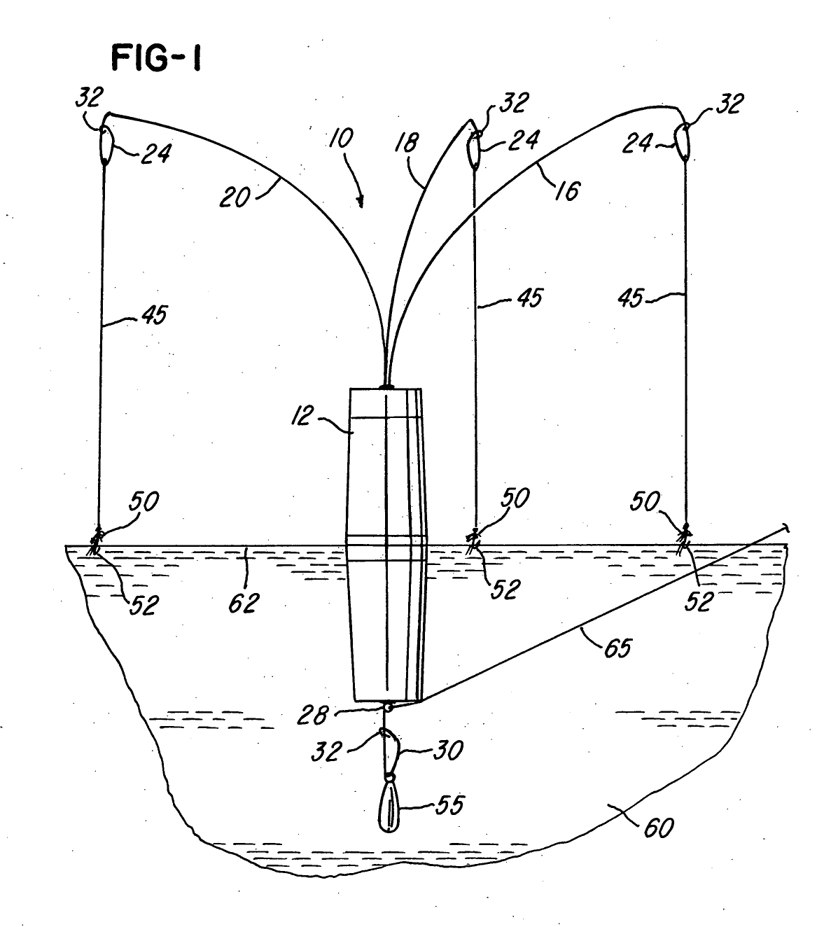

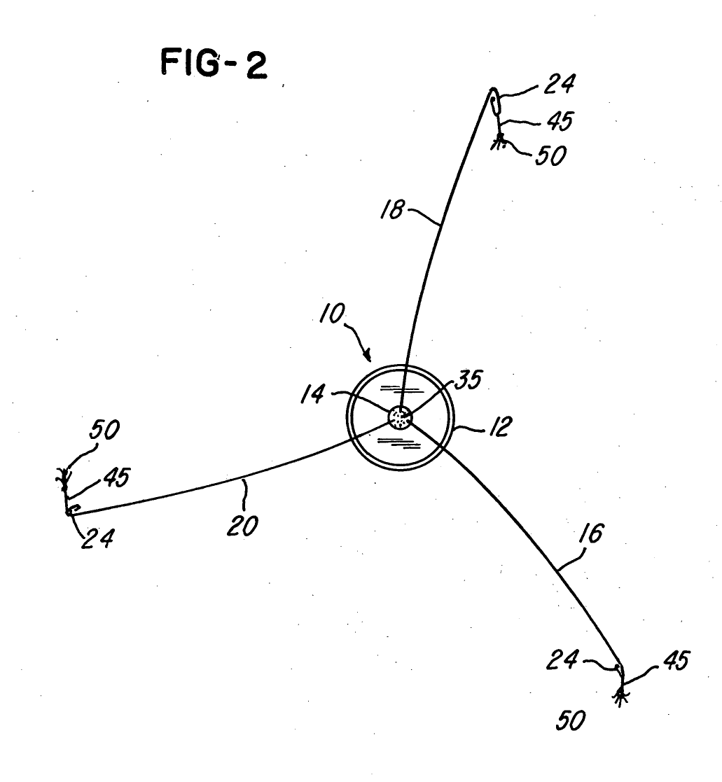

Referring to FIG. 1, a fine flexible leader line 45 in the form of a plastic or nylon leader connects the outer end portion or fastener 24 of each spring wire to a bait 50 having a fish hook 52. The bait 50 may be in the form of an artificial fly as commonly used for fly fishing or the bait 50 may be a live bug or worm attached to the hook 52. The upper end portion of each leader line 45 may have a tied loop which hooks onto the fastener 24, and the lower end portion of the leader line may be connected or attached to the bait 50 in a conventional manner. While three spring wires 16, 18 and 20 are illustrated in FIGS. 1-3 for the lure 10, one or two or more than three spring wires may be connected to the float body 12, whatever may be desired for fishing.

As shown in FIGS. 1 & 3, a weight member 55, such as a lead sinker, is attached or connected to the fastener 30 formed from the lower end portion of the spring wire 20. The size of the weight 55 is selected so that when the lure 10 is placed in a body of water 60, the center portion of the float body 12 is located at the water surface 62, and each of the baits 50 is touching or adjacent the water surface, as shown in FIG. 1. However, a suitable weight 55 may also be incorporated in the lower portion of the float body 12 if a fixed weight is predetermined and it is not necessary to provide for selecting a specific weight 55. As also shown in FIG. 1, a flexible fishing line 65 extends from a fishing pole (not shown) and is connected to the eyelet 28 at the bottom of the float body 12. However, the fishing line 65 may be connected or attached to another location on the float body 12 or to one of the fasteners 24.

As apparent from the drawings and the above description, it is apparent that a fishing lure constructed in accordance with the invention provides desirable features and advantages. For example, by connecting the top of the float body 12 to a bait 50 by the elongated flexible element or spring wire 16 so that the bait 50 is touching the water surface 62 when the float body 12 is floating on still water, any movement of the lure 10 or movement of the water causes the bait 50 to bounce or dance on the water surface 62 which provides the appearance of a live bait or fly caught or resting on the water surface. The movement of the lure may be caused by a slight pull on the fishing line 65 extending from the fishing pole or movement of the water due to wind on the water surface. When a plurality of flexible elements or wires 16 extend from the float body 12 and support corresponding baits or flies 50, the fishing lure provides the appearance of a swarm of flies touching the water surface and then flying away from the surface and returning to the surface.

While the form of fishing lure herein described constitutes a preferred embodiment of the invention, it is to be understood that the invention is not limited to this precise form of the invention, and that changes made therein without departing from the scope and spirit of the invention as defined in the appended claims.

What is claimed is:

1. A fishing lure adapted to float on the surface of water, comprising
a buoyant body adapted to float on the surface of the water,
at least one elongated flexible element having an inner portion connected to said body,
said flexible element projecting laterally outwardly from said body above the surface of the water and having an outer portion spaced laterally outwardly from said body,
a bait comprising a fish hook and connected to said outer portion of said flexible element,
said bait supported by said outer portion of said flexible element adjacent the surface of the water when said body is floating on the water, and
said flexible element cooperating with said body to produce a dancing effect of said bait on the surface of the water in response to movement of the water and/or said body.

2. A fishing lure as defined in claim 1 wherein said buoyant body has a lower portion positioned below the surface of the water and an upper portion projecting into air above the surface of the water, and said inner portion of said flexible element is connected to said upper portion of said body.

3. A fishing lure as defined in claim 1 and including a flexible plastic leader line connecting said outer portion of said flexible element to said bait.

4. A fishing lure as defined in claim 1 wherein said body is elongated and has a lower end portion and an upper end portion, said lower end portion has sufficient weight to position said lower end portion below the surface of the water and said upper end portion in the air above the surface of the water, and said inner portion of said flexible element is connected to said upper end portion of said body.

5. A fishing lure as defined in claim 4 and including a weight member releasably connected to said lower end portion of said body.

6. A fishing lure as defined in claim 1 and including an eyelet connected to said body for attaching a fishing line extending from a fishing pole.

7. A fishing lure as defined in claim 1 wherein said outer portion of said flexible element includes an integrally formed releasable fastener connected to said bait.

8. A fishing lure as defined in claim 1 and including a plurality of said flexible elements each having an inner portion connected to said body and an outer portion supporting a bait comprising a fish hook.

9. A fishing lure as defined in claim 1 wherein said elongated flexible element comprises a section of a flexible stainless steel spring wire.

10. A fishing lure adapted to float on the surface of water, comprising
a buoyant body adapted to float on the surface of the water,
at least one elongated flexible spring wire having an inner portion connected to said body,
said spring wire projecting upwardly and laterally outwardly from said body above the surface of the water and having an outer portion spaced laterally outwardly from said body,
a bait comprising a fish hook and connected by a flexible plastic leader line to said outer portion of said spring wire,
said bait supported by said leader line and said outer portion of said spring wire, adjacent the surface of the water when said body is floating on the water, and said spring wire cooperating with said body to produce a dancing effect of said bait on the surface of the water in response to movement of the water and/or said body.

11. A fishing lure as defined in claim 10 wherein said body is elongated and has a lower end portion and an upper end portion, said lower end portion has sufficient weight to position said lower end portion below the surface of the water and said upper end portion in the air above the surface of the water, and said inner portion of said spring wire is connected to said upper end portion of said body.

12. A fishing lure as defined in claim 11 and including a weight member releasably connected to said lower end portion of said body.

13. A fishing lure as defined in claim 10 wherein said spring wire defines an eyelet adjacent said lower end portion of said body for attaching a fishing line extending from a fishing pole.

14. A fishing lure as defined in claim 10 wherein said outer portion of said flexible element includes an integrally formed fastener connected to said leader line.

15. A fishing lure as defined in claim 10 and including a plurality of said flexible spring wires each having an inner portion connected to said body and an outer portion connected to a corresponding said leader line supporting a corresponding bait comprising a fish hook.

16. A fishing lure as defined in claim 15 wherein each said spring wire comprises a section of a flexible stainless steel spring wire.

17. A fishing lure as defined in claim 15 wherein said buoyant body is elongated and has a longitudinally extending center hole, said inner portion of each said spring wire extends into said center hole, and an adhesive securing each said inner portion to said body.

18. A fishing lure adapted to float on the surface of water, comprising
a buoyant body adapted to float on the surface of the water,
a plurality of elongated spring wires each having an inner portion connected to said body,
each said spring wire projecting upwardly and laterally outwardly from said body above the surface of the water and having an outer portion spaced laterally outwardly from said body,
a bait comprising a fish hook and connected by a leader line to said outer portion of each said spring wire,
each said bait supported by said outer portion of said spring wire adjacent the surface of the water when said body is floating on the water, and
each said spring wire cooperating with said body to produce an independent dancing effect of each said bait on the surface of the water in response to movement of the water and/or said body.

19. A fishing lure as defined in claim 18 wherein said buoyant body is elongated and has a lower end portion positioned below the surface of the water and an upper end portion projecting into air above the surface of the water, and said inner portion of each said spring wire is connected to said upper end portion of said body.

20. A fishing lure as defined in claim 19 and including a weight member connected to said lower end portion of said body.
